(19) United States
(12) Patent Application Publication
(10) Pub. No.: US 2009/0305901 A1
(43) Pub. Date: Dec. 10, 2009

(54) High-Throughput Cell-Based Screening System

(75) Inventors: Livia Seemann, Zurich (CH); Frauke Greve, Zurich (CH); Jan Lichtenberg, Zurich (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Eidgenossiche Technische Hochschule Zurich, Zurich (CH)

(21) Appl. No.: 12/224,468

(22) PCT Filed: Feb. 28, 2007
(86) PCT No.: PCT/EP2007/001716

§ 371 Date: Feb. 27, 2009

(30) Foreign Application Priority Data
Mar. 1, 2006 (EP) 06004090.4

(51) Int. Cl. C40B 30/00; C40B 60/12

(52) U.S. Cl. 506/7; 506/39

(57) ABSTRACT

A (bio-)chemical assay on sensing objects (4) e.g. for use as a drug screening assay on living cells, as well uses and a method for making such an integrated system is proposed. The assay is comprising a base element (1) with on a surface an array of multiple immobilisation points (5) for individual sensing objects such as cells (4) or groups of a few sensing objects, and a flow chamber (8) bordered on a first lateral side by said base element (1) and covering said base element (1) at least in the region with the array of immobilisation points (5), wherein the flow chamber (8) on an entry-side comprises at least one or two inlets (17) for the introduction of different test solutions into the flow chamber (8) in a flow direction (20), and on an exit-side located opposite to the entry-side comprises at least one outlet (10) for the test solutions, wherein these inlets (17) are located substantially in a plane parallel to the surface of the base element (1) and spaced apart in a direction perpendicular to the flow direction (20) of the test solutions such that the test solutions flow across over the array of multiple immobilisation points (5) and sensing objects (4) located thereon in a parallel laminar flow, such that there is no interference and/or or well-defined and reproducible interference between the flow of the different test solutions over defined groups of the array of multiple immobilisation points (5).

### TECHNICAL FIELD

The disclosure relates to a (bio-)chemical assay on sensing objects such as e.g. for use as a drug screening assay on living cells, as well uses and a method for making such an integrated assay.

### BACKGROUND OF THE INVENTION

Cell-based screening systems constitute a common method in pharmaceutical research to study drug-induced effects on cells. These screening systems are based on delivering drugs in a wide concentration range (3-6 orders of magnitude) to incubated cell populations. In standard systems, this process is performed in well plates (up to 1536 wells with effective volumes ranging from 1 to 100 μl), into which the cells and drugs are pipetted. The surface of these wells is usually pretreated with proteins such as poly-L-lysine, fibronectin or collagen to offer good adhesion conditions for the cells. The drugs are diluted off-line to their working concentration either manually or by automated robotic systems and are dispensed into the well plates, so that the cells and the respective drugs are separated from each other in different wells during incubation and screening.

This technique is not only time and labour-intensive, it also requires large sample compound quantities.

### SUMMARY OF THE INVENTION

One of the objectives of the present invention is therefore to provide a highly automated and reliable, miniaturised (bio)chemical assay, which for example can be used as a system for drug screening on living cells.

The proposed system is specifically comprising a base element with on (or through) a surface an array of multiple immobilisation points for sensing objects such as e.g. individual (living) cells or groups of a few (living) cells, and a flow chamber bordered on a first lateral side by said base element and covering said base element at least in the region with the array of immobilisation points. The flow chamber on an entry-side comprises at least one, preferably two or more inlets for the introduction of different test solutions into the flow chamber in a flow direction, and on an exit-side located opposite to the entry-side it comprises at least one outlet for the test solutions, wherein these inlets are located substantially in a plane parallel to the surface of the base element and spaced apart in a direction perpendicular to the flow direction of the test solutions such that the test solutions flow across over the array of multiple immobilisation points and cells located thereon in a parallel laminar flow. Additionally, the unit is structured such that there is no interference between the flow of the different test solutions over defined groups of the array of multiple immobilisation points. Like that, each group can be associated to the exposure to a specific test solution. Alternatively it is however also possible, due to the laminar flow and the corresponding clearly defined diffusion based mixing between adjacent flows of test solutions, to take advantage of the well-defined and reproducible interference between the flow of the different test solutions over defined groups of the array of multiple immobilisation points. Due to the well-defined homogeneous distribution of sensing objects, like e.g. the cells, on the surface of the base element in the latter case it is for example possible to automatically analyze the resulting information based on image recognition and association with the well-defined concentration distribution profile.

Generally when talking about “sensing objects”, this is intended to mean in the following any kind of object or particle which reacts on the test solution in a measurable and a recognisable way. So the sensing object may for example be living or non-living cells or groups of such cells. The sensing objects may on the other hand also be inorganic or organic particles, such as for example beads, which may have attached receptors, proteins, sugars, combinations thereof or the like, which react on the test solution in some measurable way. On the other hand if in the following mention is made solely of cells as sensing objects, this is also intended to include the above-mentioned difference sensing objects, e.g. the above-mentioned particles or the like.

To achieve low reagent consumption e.g. in a highly parallel drug-screening approach with an integrated detecting or sensing step, a miniaturized equivalent of a micro titerplate and a dilution stage, both integrated in one system, as given above, are desired, so that several functions such as the immobilization and culturing of cells inside an incubation chamber, the drug dilution, and the drug-screening functions can be integrated.

The immobilization of sensing objects or specifically of cells can be achieved using methods such as physical retention chambers, where cells are trapped by an inserted cellulose-nitrate membrane [1], di-electrophoretic methods using an inhomogeneous electrical field [2, 3], or the capturing of single cells either at the entrance of a silicon channel [4] or by pneumatic anchoring [5, 6]. Also, multi-height ‘sandbag’-type structures have been proposed for particle trapping [7] and are possible. In addition to physical methods, surface-chemical strategies such as the use of adhesion proteins patterned by photolithography [8], micro-contact printing [9] or the use of self-assembled monolayers, are promising approaches to facilitate the immobilization of cells on a chip surface.

The mixing of a test component or drug and a buffer solution to produce a wide concentration range is needed e.g. for drug-screening experiments. As manual dilution is hard to perform on low volumes, micro-fluidic diluters based on polymeric or inorganic materials have been developed. Serial [10] and combined serial and parallel mixing [11], combinatorial 3D mixing over several flow magnitudes [12] and the use of dilution gradients [13] have been proposed. As micro-fluidic mixers usually operate in the low-Reynold's-number regime, chaotic mixing has been introduced to improve the mixing of the respective drug and buffer solutions [14, 15].

In a first preferred embodiment of the present invention, the assay correspondingly comprises a micro-fluidic dilution element for automatically generating different concentrations of test solutions from at least one basic liquid introduced via a first inlet into the dilution element and at least one test liquid or drug introduced via a second inlet into the dilution element, and wherein the generated different test solutions or drug solutions are introduced into the flow chamber via the different inlets.

According to a further preferred embodiment of the present invention, the flow chamber comprises at least two sensing object loading ports, wherein preferably the sensing object loading ports or cell loading ports are located on opposite lateral sides of the flow chamber. It is for example possible to have a direction of introduction of the sensing object which is orthogonal to the flow direction during the subsequent exposure to the test solutions. The sensing objects may however also be introduced via the same channels as the test solution.

Preferably the immobilisation points are pneumatic anchoring points for individual sensing object like cells. It is for example possible to structure the immobilisation points as holes penetrating the base element. The diameter of such holes is preferably smaller than the average diameter of the sensing object such as cells used in the assay, wherein preferably the diameter of the holes is in the range of 1-20 μm, even preferably in the range of 3-10μm.

According to a further preferred embodiment of the invention, the array of multiple immobilisation points comprises between 10-5000, preferably between 200-2000 individual immobilisation points (e.g. symmetrically oriented in a rectangular matrix with equal spacing in both directions), wherein these immobilisation points are preferably grouped into a number of individual defined groups corresponding to the number of inlets for the introduction of different test solutions (each group e.g. comprising 200 immobilisation points), and wherein even more preferably these individual groups are spatially separated from each other in a direction orthogonal to the direction of the flow such that there is no interference between the flow of the different test solutions over these defined groups.

In order to have as little consumption of test compound or drug for the screening, it is, according to a further preferred embodiment of the invention, possible to structure the flow chamber such that it has a volume in the range of 0.1-100 μl, preferably in the range of 0.3-1 μl. The flow chamber preferably has a height perpendicular to the plane of the base element in the range of 10-200 μm, preferably in the range of 50-150 μm.

The flow chamber preferably comprises at least two outlets for the test solutions, preferably an equal number of outlets as there is inlets, wherein these outlets are located opposite and in a spacing adapted to the one or identical to the one of the inlets. This symmetry makes sure that there is laminar flow.

According to a preferred construction of the invention, the base element is a plastics, glass or ceramics element, or also a silicon orifice chip, preferably based on silicon-on-insulator-technology. Also combinations of such materials, e.g. layered structures or the like are possible. Preferably the base element has a size in the range of 1×1 mm² to 20×20 mm², or of 2×2 mm² to 20×20 mm², preferably in the range of 5×5 mm² to 10×10 mm².

According to a further preferred embodiment of the invention, an integrated system is proposed wherein the base element is at least partially embedded in a support plate, and wherein on to of the support plate there is located a cover plate also covering the base element, said cover plate or support plate preferably comprising a microfluidic dilution system given by a system of cascading channels with dilution stages. Preferably the support plate and/or the cover plate are based on plastic, glass, silicon and/or ceramics, in respect of handling it may be advantageous to use an elastomeric material, preferably based on poly(dimethylsiloxane).

Specifically, it can be shown to be advantageous, if there is provided 3-7, preferably five inlets substantially equally spaced apart in a direction perpendicular to the flow direction by between 200-1500 μm, preferably between 400-1000 μm, wherein preferably the inlets have a diameter in the range of 50-200 μm, and wherein the flow rate in the flow chamber is in the range of 4-50 μL min-1, and wherein preferably the micro-fluidic dilution system provides solutions in a concentration range of 3-6 orders of magnitude.

In an even more integrated design, it is possible to additionally have an analysis unit, preferably an optical analysis unit.

Preferably, the flow chamber is a substantially contiguous cavity, possibly locally supported by supports.

The present invention further relates to a method for (bio)chemical investigation of sensing objects, preferably to automated drug screening using an assay as defined above. The method comprises at least the following steps, wherein the steps may be in the sequence as given below, wherein e.g. steps (II) and (III) may also be carried out concomitantly.

(I) sensing objects are introduced into the flow chamber (e.g. as a suspension) and immobilised on the immobilisation points, optionally in case of cells as sensing objects followed by a culturing step, e.g. leading to a confluent layer;

(II) test solution dilution, preferably by means of an integrated dilution element, introduction of the test solutions into the flow chamber via the inlets (and exposing the immobilised sensing objects to the test solutions by parallel laminar flow across over the sensing objects, optionally followed and/or accompanied by incubation in case of cells;

(III) analysis of the influence on the sensing objects, preferably by means of optical interrogation.

Specifically and preferably, the sensing objects are introduced in step (I) into the flow chamber and immobilised on the immobilisation points by means of hydrostatic pressure, wherein preferably the immobilisation points are holes with a diameter smaller than the average diameter of the sensing objects, penetrating the base element.

Furthermore, the present invention relates to a method for making an assay as described above, wherein the base element is produced from a silicon chip by means of reactive-ion-etching and/or anisotropic wet etching (preferably both, the two from different sides), wherein the base element is embedded in an elastomeric support plate, wherein a cover plate with a flow chamber and the inlets and outlets as well as an integrated microfluidic dilution system is produced from an elastomeric material based on a template at least comprising the dilution topology, and wherein the cover plate is attached and connected to the support plate with the embedded base element.

Further embodiments of the present invention are outlined in the dependent claims.

### SHORT DESCRIPTION OF THE FIGURES

In the accompanying drawings preferred embodiments of the invention are shown in which:

FIG. 1 System schematic: (i) silicon chip with perforated membrane embedded into PDMS; (ii) micro-fluidic system mounted on the chip after oxygen-plasma activation;

FIG. 2: Micrograph of the cell-screening system with the online diluter, the 0.5-μl incubation chamber and the cell-loading ports (channel contrast emphasized);

FIG. 3: Design considerations of the micro-fluidic incubation chamber with a denoting the distance between two incoming laminar streams, l the chamber length and L_{Diffmax} the maximally allowed diffusion to avoid interference between neighbouring streams, i.e. concentration gradients within one cell bed. (a=200 μm, l=1400 μm; L_{Diffmax}=100 μm);

FIG. 4: Schematic of (a) the whole micro-fluidic design and (b) the dilution stage with the different flow rates in each branch;

FIG. 5: Silicon microchip fabrication: the silicon wafer is photo-lithographically patterned, and the orifices are etched from the front side using RIE. Then, the back side is patterned using 1000 nm silicon nitride before anisotropic KOH etching of the silicon. Finally, the membrane is fully released by isotropic etching of the intermediate silicon-oxide layer with HF;

FIG. 6: Cell immobilization: Micrograph of fibroblasts (20 μm diameter) immobilized on the orifices of the silicon chip so that a homogenous cell density is achieved;

FIG. 7 (a): Micrograph of the micro-fluidic diluter which was qualitatively verified with DI water and blue food colour as drug replacement. The black boxes showed the first, second and third dilution stage to produce relative concentrations of 10%, 1% and 0.1%, (b): Quantitative evaluation of the drug diluter using sodium fluorescein as a ‘drug’ and a photo-multiplier for performing fluorescence measurements to quantify the ‘drug’ concentration. Note that the relative concentrations are plotted on a logarithmic scale;

FIG. 8: Micrographs of incubated normal human dermal fibroblasts (NHDFs) after 6 days in culture; and

FIG. 9 (a): Fluorescence image of cells stained by a cell tracker in the incubation chamber; right: highest cell tracker concentration; left: lowest cell tracker concentration. The total cell tracker flow rate was 1.25 μl/min for 20 min, (b): Average brightness of the different cell beds.

### DETAILED DESCRIPTION OF THE PREFERRED EMBODIMENTS

In the following and with reference to the drawings, the invention as generally outlined above shall be illustrated. The now following description is however for the purpose of illustrating the present preferred embodiments of the invention and shall not be construed for the purpose of limiting the same as defined in the appended claims.

To achieve low reagent consumption in a highly parallel drug-screening approach with integrated detecting or sensing step, a miniaturized equivalent of a micro titer-plate and a dilution stage, both integrated in one system, are desired, so that several functions such as the immobilization and culturing of cells inside an incubation chamber, the drug dilution, and the drug-screening functions have to be integrated.

The immobilization of cells can be achieved using methods such as physical retention chambers, where cells are trapped by an inserted cellulose-nitrate membrane [1], di-electrophoretic methods using an inhomogeneous electrical field [2, 3], or the capturing of single cells either at the entrance of a silicon channel [4] or by pneumatic anchoring [5, 6]. Also, multi-height ‘sandbag’-type structures have been proposed for particle trapping [7]. In addition to physical methods, surface-chemical strategies such as the use of adhesion proteins patterned by photolithography [8], micro-contact printing [9] or the use of self-assembled mono-layers, are promising approaches to facilitate the immobilization of cells on a chip surface.

The mixing of a drug and a buffer solution to produce a wide concentration range is needed for drug-screening experiments. As manual dilution is hard to perform on low volumes, micro-fluidic diluters based on polymeric or inorganic materials have been developed by several groups. Serial [10] and combined serial and parallel mixing [11], combinatorial 3D mixing over several flow magnitudes [12] and the use of dilution gradients [13] have been proposed. As micro-fluidic mixers usually operate in the low-Reynold's-number regime, chaotic mixing has been introduced to improve the mixing of the respective drug and buffer solutions [14, 15].

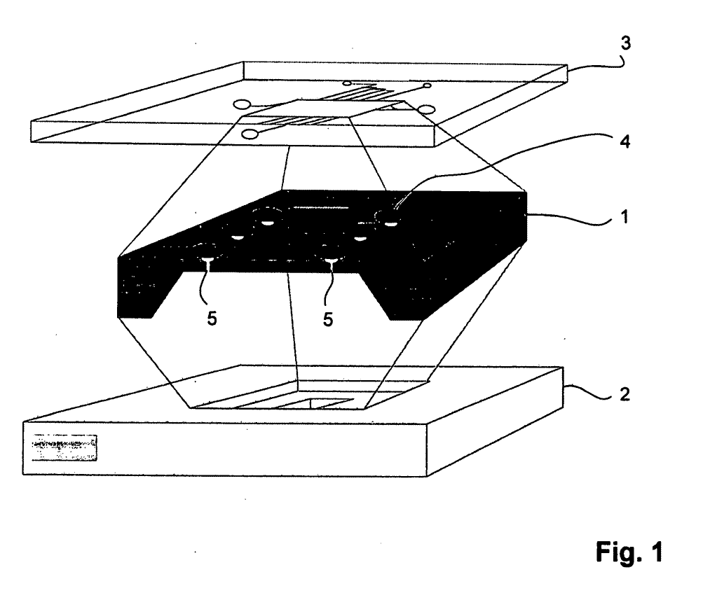

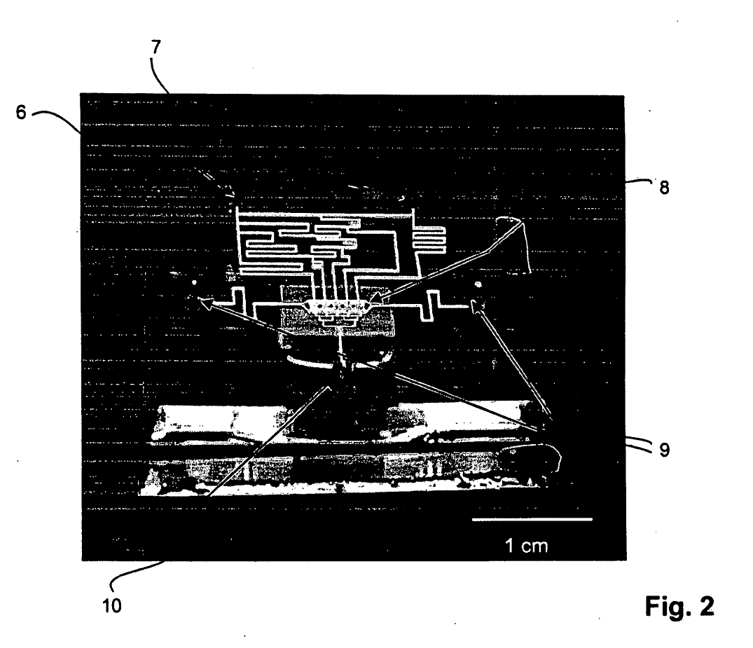

Although a variety of miniaturized dilution stages have been reported, the majority is limited to a dilution range of about two orders of magnitude. Here, we present a microchip-based system containing a miniaturized equivalent of a micro-titerplate as well as a micro-fluidic dilution cascade (FIG. 1). The device can be used for all essential steps of the screening process: (I) immobilization of a defined number of cells to yield a homogeneous array, (II) drug dilution, (III) incubation, and (IV) optical interrogation. The core of this system is a 7×5-mm² silicon chip 1 with an array of 1000 orifices 5 for cell trapping. As this chip 1 does not provide enough area for the micro-fluidic mixers, those are cast on a 2×2-cm² poly(dimethylsiloxane) (PDMS) elastomer substrate 3. After assembly, the diluter, a 0.5-μl incubation chamber 8 and the cell-loading ports 9 constitute a single unit (FIG. 2). The diluter has two inlets 6,7 for the cell medium and the drug stock solution, both of which are subsequently mixed in a cascading channel system (relative concentrations: 100%, 10%, 1%, 0.1%, 0% of the original drug stock solution). Additionally, the system features two cell loading ports 9 to load the cells into the incubation chamber 8 and to regularly exchange the medium during pre-screening incubation.

The experimental data presented in this paper illustrate that this hybrid microsystem allows for performing a drug-screening assay for 5 sample concentrations with only 0.4 μl/min of the sample drug.

### Device Description and Modelling

A schematic of the device is shown in FIG. 1. The microsystem consists of three distinct components: (a) a 7×5-mm² silicon chip 1 with an array of 1000 orifices 5 for cell trapping, (b) 2×2-cm² elastomeric substrate 8, into which the chip 1 is embedded, to enlarge the real estate of the device, and (c) a micro-fluidic cover 3 with the integrated diluter cascade, made of PDMS. A cell screening with this device is performed as follows: first, a cell suspension is pumped through the incubation chamber, and the cells 4 are trapped on the orifices 5. This assures a homogeneous cell distribution inside the chamber. Then, the excess cells are washed away by a laminar buffer stream to leave the chamber with a defined number of cells in a homogeneous arrangement. Cells are only immobilized during loading and can afterwards proliferate freely during the incubation step. The cells are typically incubated for several days before the actual screening process is performed. For screening, only a minute amount of the drug is pumped into one inlet of the dilution cascade, where it is mixed with a buffer solution from the other inlet to yield the relative final concentrations of 100%, 10%, 1%, 0.1%, 0% of the drug. The five diluter outputs 17 provide laminar streams over the respective areas of the immobilized cells, so that each stream only perfuses a defined part of the overall cell area. Simultaneously or sequentially, the cellular response can be optically assessed by e.g. adding specific fluorescent tags to the buffer stream.

### Silicon Orifice Chip

The cells 4 are immobilized on the silicon chip I by individual trapping on an array of 5×200 orifices 5 owing to a slight pressure difference between the inside and the outside of the incubation chamber 8. Typically, a single cell is immobilized on one orifice 5 during this process. This technique, denoted as ‘pneumatic anchoring’, has been previously described by [5] and by our group [6] for bio-electronic CMOS chips. Cell immobilization is used here for mainly two reasons. First, the technique allows for loading the chamber with an exactly defined number of cells for each experiment. Consequently, the resulting fluorescence intensity measurements lead to reproducible and statistically relevant data for the different drug concentrations.

Second, a homogeneous cell carpet is obtained owing to the equal spacing between the orifices; without immobilization features, the cell loading would lead to irreproducible and spatially imbalanced cell populations that are not suitable for screening experiments. After the loading step has been completed, the immobilization force has been found to be not to disturb the cell proliferation. Although cells might migrate during the incubation, the homogeneous nature of the cell carpet is preserved.

As the diameter of the cells used in this project, normal human dermal fibroblasts (NHDFs), is approximately 20 μm, orifices in the range of 5 μm need to be fabricated to prevent any suction of the cells through the orifices. Silicon was used as the chip material, because of the available precision etching techniques. Orifices 5 have been etched from the frontside by reactive-ion etching, their back-side has been thinned by anisotropic wet etching to a 5-μm membrane to reduce the lateral widening of the orifices during fabrication. As silicon technology is comparably expensive, the chip size is limited to the absolutely necessary area (7×5 mm²). To have enough space around this chip for the integration of the micro-fluidics, the chip has been seamlessly embedded into a larger, 2×2-cm² PDMS substrate 2 before the micro-fluidic cover 3 has been bonded onto the chip 1. No leakage of drugs into the cleft between the chip and the micro-fluidic system has been observed.

### Micro-Fluidic System

All the necessary parts for the drug handling have been integrated into the micro-fluidic cover (FIG. 2). The orifice array is covered by a 0.5-μl incubation chamber 8 (3.5 mm wide, 1.4 mm long, and 100 μm high). Two loading ports 9 (5 mm long) have been provided to inject the cell suspension into the incubation chamber 8.

The cell loading stream is perpendicular to the main buffer stream. Two inlets 6,7 are provided for the buffer solution and the drug stock which are mixed in the cascading dilution stage to produce the desired concentrations. Five outlets 17 (100 μm wide, 700 μm spacing) provide the drug dilution to five cell arrays. On the opposite side of the chamber, a symmetrical shape port 10 leads to the waste reservoir.

As micro-fluidic devices generally operate in the laminar-flow regime, mixing in the dilution stage is only achieved by diffusion. For the structure presented here this also holds true as the Reynold's number is between 0.1 and 2, which is far below the threshold for turbulent flow. To ensure complete mixing, the channel geometries have to be adapted in terms of width and length, and the corresponding flow rates have to be chosen accordingly. The mixing ratios are defined by the flow rates of the drug and the buffer solution at the branches of the diluter stage.

At each interception point, the flow rate of the incoming drug (or output of the previous dilution stage) is 9 times smaller than the flow rate of the buffer to obtain the desired dilution of 1:9. Thus, using three cascading levels with three interception points, dilutions of 10%, 1%, 0.1% can be achieved. This modular design can be extended to more dilution levels and can be adapted to different dilution ratios.

Concentration errors in each stage propagate to the next level so that a careful design and fabrication of this structure are essential. While the residence time of drug molecules in the diluter branches must be long enough to assure complete mixing, the residence time in the incubation chamber must be as short as possible to avoid unwanted interference between neighbouring drug streams. The design requirements for the diluter and the incubation chamber are therefore strongly interrelated, and an optimization is necessary.

### Design and Modeling Approach

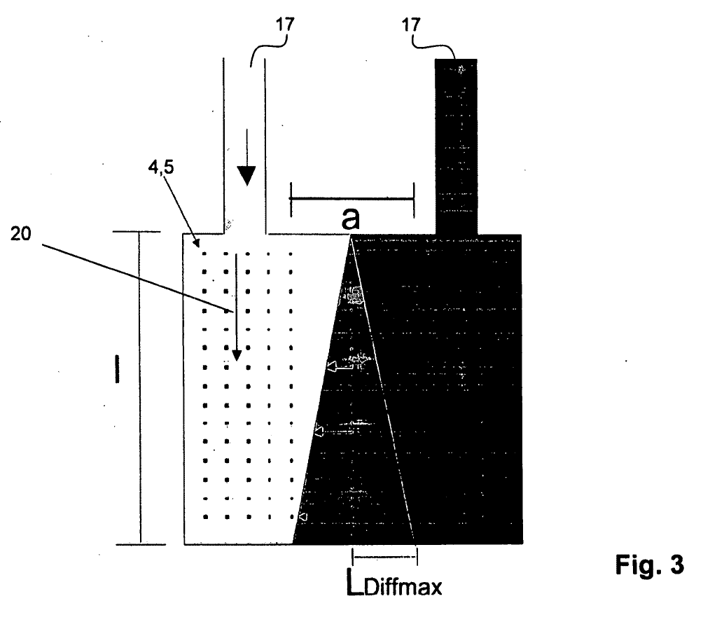

FIG. 3 shows a schematic of the incubation chamber. The five individual streams are flowing from the dilution stage into the chamber, where the cells 4 are immobilized and brought into contact with the drugs. The boundary conditions for the chamber design are as follows:

1. Mixing of the adjacent streams within the incubation chamber should be minimized.

2. The flow rates Q1 to Q5 within the incubation chamber should be the same to provide an equal width of the drug streams in the incubation chamber.

Difflusion in the chamber causes a widening of the concentration profiles inside the incubation chamber. The maximal diffusion length, which is still acceptable, is given by

$${L}_{Diff max} < \frac{a}{2} \qquad ( 1 )$$

with a denoting the spacing between two orifice beds.

The maximum time that is allowed without mixing to occur is given by

$$t < \frac{{L}_{Diff max}^{2}}{2 D} = \frac{{a}^{2}}{8 D} \qquad ( 2 )$$

with D as the diffusion constant.

Consequently, the minimum required flow rate can be calculated by:

$${Q}_{min} > \frac{A \cdot l}{t} \qquad ( 3 )$$

with A as the chamber cross-section and l as the chamber length.

For the device described in this disclosure, the minimum flow rate inside the incubation chamber should be at least 5.88 μL min-1 taken all design parameters into account(a=200 μm; D=10−9 m² s-1 for a typical biomolecule; A=0.35 mm²; 1=1.4 mm).

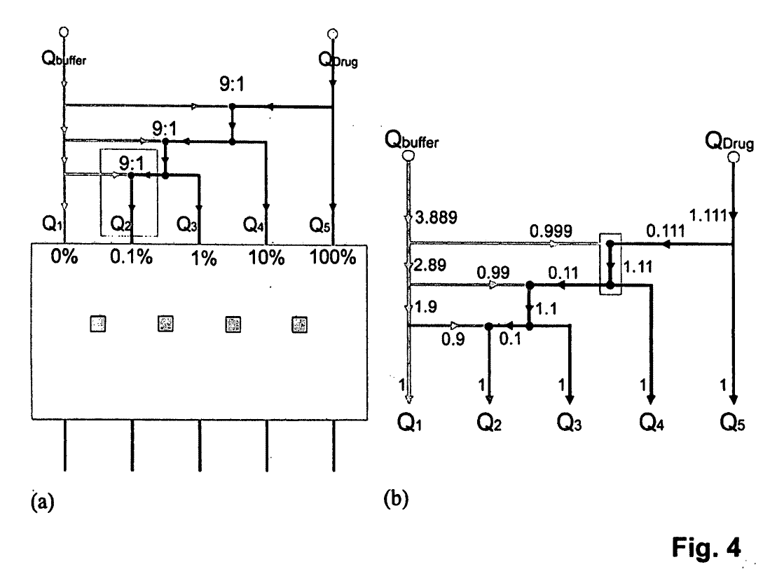

FIG. 4 (a) shows a schematic of the diluter: for both inputs, the buffer solution and the drug stock solution are directly connected to the ports 1 and 5 thus providing 0% and 100% streams. The diluter is realized as a cascading structure with three stages that mix the two solutions to the desired concentrations and connect these to the ports 2 to 4.

The requirements for the dilution stage are:

1. Mixing ratios are based on the different flow rates.

2. The output flow rates of the dilution stage Q1 to Q5 are equal (normalized to 1 in this discussion).

3. The drug concentrations of Q1 to Q5 should be C5=10 C4=100 C3=1000 C2; C1=0 leading to relative concentrations of 100%, 10%, 1%, 0.1%, 0% of the drug stock solution.

The mixer structure has been designed using a lumped-element, equivalent-circuit model, in which each channel segment is represented by an electrical resistor. The individual flow rates and the resulting resistances of each branch can be determined by solving the linear system of equations derived from the equivalent circuit using Kirchhoff's theory. The flow rate corresponds to an electrical current and the flow resistance to an electrical resistance. The individual flow rates can be calculated using Kirchhoff's nodal rule as shown in FIG. 4 (b). For the diluter output stream Q2 with a normalized flow rate of 1, the ratio of the both incoming streams is 9:1 leading to a flow rate in the branches of 0.9 and 0.1, respectively (at each node the sum of the incoming currents equals the outcoming current). The flow rates in the other branches can now be calculated bottom-up. The results are shown in FIG. 4 (b).

To achieve complete mixing in each branch of the diluter, a minimum residence time has to be assured. This condition is met for the overall system, if it is fulfilled for the mixing branch with the highest flow rate and the shortest channel length (marked with the grey box in FIG. 4 (b)). If mixing can be guaranteed in this branch, the liquids in all other channels will be completely mixed as well. The flow rate of the mixing channel can be calculated by first determining the flow rates in the diluter output streams Q1 to Q5. As all five branches of the diluter have the same flow rate and all drug streams are directed into the incubation chamber, the outlet flow rates Q1 to Q5 can be determined by

$${Q}_{1 - 5} = \frac{{Q}_{chamber}}{5} \qquad ( 4 )$$

with Q_{chamber} as the minimum flow rate in the chamber.

The flow rate and the time required for a complete mixing can then be calculated by

Q_{channel}=1.11·Q₁₋₅ (5)

with Q_{channel} as the flow rate of the shortest channel, and

$${t}_{channel} = \frac{{L}^{2}}{2 D} \qquad ( 6 )$$

with L as the half width of the mixing channel,
leading to a minimum channel length of

$${l}_{channel} > \frac{{Q}_{channel } \cdot {t}_{channel}}{A} \qquad ( 7 )$$

and a minimal channel-to-chamber-length ratio of

$$\frac{{l}_{channel}}{{l}_{chamber}} = \frac{1}{5} ( \frac{{A}_{chamber}}{{A}_{channel}} ) {( \frac{{L}_{Diff channel}}{{L}_{Diff chamber}} )}^{2} \frac{1}{1.11} \qquad ( 8 )$$

The minimum required length of the channel to ensure complete mixing is then 2.7 mm for the given parameters (A_{channel}=0.01 mm²; Q1-5=1.176 μL min1; Q_{channel}=1.305 μL min-1; t_{channel}=1.25 sec). To increase the robustness of the system, the channel length was designed to be 6 mm. Due to the required length, the channels are realized as meander-shape structures on the 2×2 cm² micro-fluidic chip.

After the flow rate in each branch has been determined, the required resistance values can be analytically calculated using Kirchhoff's mesh and nodal rules.

Then, the electrical network can be translated back to a fluidic network, and the desired channel lengths can be determined. Different flow resistances in the branches can be achieved by adapting the length of the channel segments (flow resistance RL˜channel length L). To assure reproducible mixing ratios even in the event of fabrication imprecisions, the cross-sections of all channels on the chip are identical. Consequently, the only variable parameter is the channel length, however, the fabrication-induced variations are relatively small for this parameter.

### Experimental

### Microchip Fabrication:

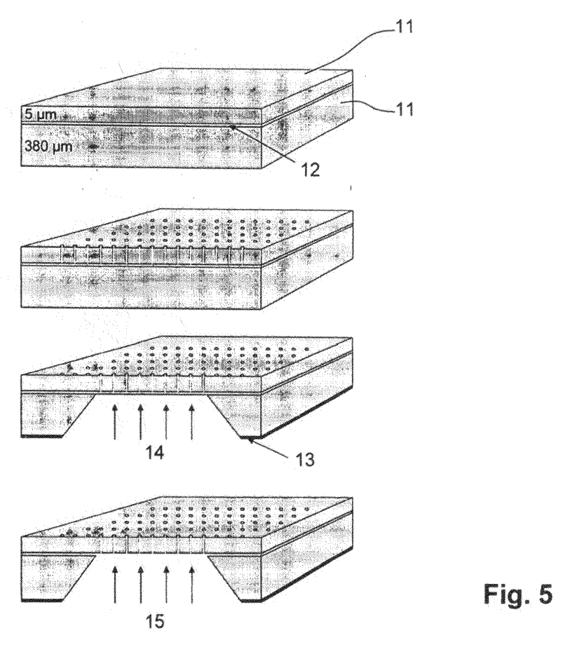

The silicon chip was fabricated in silicon-on-insulator technology (5-μm device layer, 1000 nm silicon oxide, 380-μm silicon handle wafer) using combined front-and back-side etching (FIG. 5). First, five arrays of 200 orifices featuring 5 μm diameter were etched 5-μm deep into the silicon from the front side by reactive ion etching. Due to the required resolution, a chromium mask was used to photo-lithographically pattern a 1.8 μm thick photo resist layer (S1818, Shipley, USA) that serves as an etch mask. Then, the back side of the wafer was patterned using 1000 nm PECVD silicon nitride as an etch mask for the wet-chemical etching.

This etch mask has been structured by lithography and RIE to define the membrane position. The 5-μm thick silicon membrane underneath the orifice-array was formed by anisotropic etching 14 in 6 molar KOH at 90° C. from the backside. The etching stops at the intermediate thermal silicon oxide, which was then removed using 10% aqueous HF solution 15 to fully release the membrane and to open the orifices.

The fabrication was completed by dicing the wafer into single chips. The diced chips were finally mounted on a flexible film (face down) and embedded in PDMS by a casting procedure that will be described below.

### Fabrication of the Micro-Fluidic Device:

The micro-fluidic network was formed in a second chip which is fabricated in PDMS by casting from a silicon mold featuring 100-μm-high SU-8 structures. The fabrication process was as follows: After dehydration of the silicon wafer, the SU-8 (SU-8 50, Microchem, USA) was spun onto the wafer (1250 rpm) and a two-level soft-bake (60° C. for 1 min, 95° C. for 75 min) was performed on a hotplate to evaporate the solvents and to harden the photo resist. The hotplate was switched off after the bake to let the wafer cool down slowly. Then, the UV-exposure in the mask aligner (energy dose 600 mJ/cm²) was done to transfer the desired fluidic pattern from a typesetting film mask (8 μm resolution) onto the wafer. The postexposure bake was carried out at 65° C. (1 min) followed by 95° C. (45 min), before the wafer was developed in Microchem's SU-8 developer for 10 min and washed with isopropanol. The fabrication was completed with the hard bake at 150° C. to achieve a better mechanical stability.

The PDMS replica mold was first pre-treated with the surfactant Triton-X 100 (0.05% in water), which was applied by spin coating at 1000 rpm and then dried at ambient temperature. The surfactant is needed to facilitate the mold release of the PDMS. Then, the PDMS (Sylgard 184, Dow Corning, USA) was prepared with a weight ratio of 10:1 for component A and B followed by degassing in a vacuum chamber for 30 min. The PDMS was finally poured onto the wafer and cured at 60° C. for 4 hours. After removing the PDMS layer from the master, the cast was rinsed thoroughly in warm water to remove Triton-X residues that might prevent bonding and was cut into single chips.

### Embedding of the Silicon Chip:

The silicon chip and the micro-fluidic PDMS chip have dimensions of 7×5 mm² and 20×20 mm², respectively. To prevent leaking of drugs through a cleft between these two devices, a tight seal between the silicon chip and the micro-fluidic cover is necessary. For that reason, the silicon chip was embedded into a PDMS support to form a flat surface. The chip was first placed upside-down on a flexible polypropylene film, then, the cavity underneath the membrane was sealed by a 3×3 mm² teflon (PTFE) bolt, which was pressed against the chip. The PDMS was poured around the chip and cured for 4 hours on a hotplate at 60° C. Finally, the bolt was released and the plastic film was removed from the front side leaving the silicon chip seamlessly embedded in the PDMS. To assemble the complete device, the PDMS micro-fluidic unit was irreversibly bonded onto the embedded silicon chip after oxygen-plasma activation for 30 sec, 100 W.

### External Setup:

Pipette tips (1 ml, Roth AG, Germany) were used to fill the incubation chamber with the cell suspension. For the drug-screening experiments, a stepper-motor-driven syringe pump (PicoPlus, Harvard Apparatus, USA) was used to provide the required flow rates.

Two glass syringes (ILS GmbH, Germany) with volumes of 250 μl and 1000 μl to provide a flow-rate ratio of 1:4 of the drug stock and buffer solution were connected via dispensing needles (1 mm diameter, Panacol, Germany) to the micro-fluidic device.

### Chamber Pre-Treatment:

Before the cells could be loaded, the assembled overall device was cleaned with ethanol and exposed to an oxygen plasma at 80 W for 30 min to render the surface of the PDMS less hydrophobic. Directly after removing the device from the plasma furnace, the incubation chamber was coated with the adhesion-mediating protein laminin-1 (20 μg/ml in TBS, Sigma Aldrich) for improved cell adhesion.

The chip was then incubated for 30 min, 37° C., 5% CO2 before washing with TBS (tris-buffered saline).

### Cell Preparation:

During the course of the experiments, a Normal Human Dermal Fibroblasts (NHDF) stock was cultured (Promocell, Germany, C-12300). Before each cell loading, the medium was removed from the fibroblasts and the cells were washed with TBS. Then, 0.25% trypsin in medium (Invitrogen Switzerland, 06354) in DMEM (Invitrogen, 21885-025) was added (3 min, 37° C.) to detach the cells from the surface of the Petri dish. The trypsin reaction was stopped with DMEM containing 10% FBS (Fetal Bovine Serum, Sigma, F1051) (at least 3 times the amount of trypsin) and was then centrifuged at 1500 rpm before the supernatant was removed from the cells, and fresh medium was added. The cell clusters were then detached from each other by gently pipetting the cell suspension back and forth.

### Cell Loading:

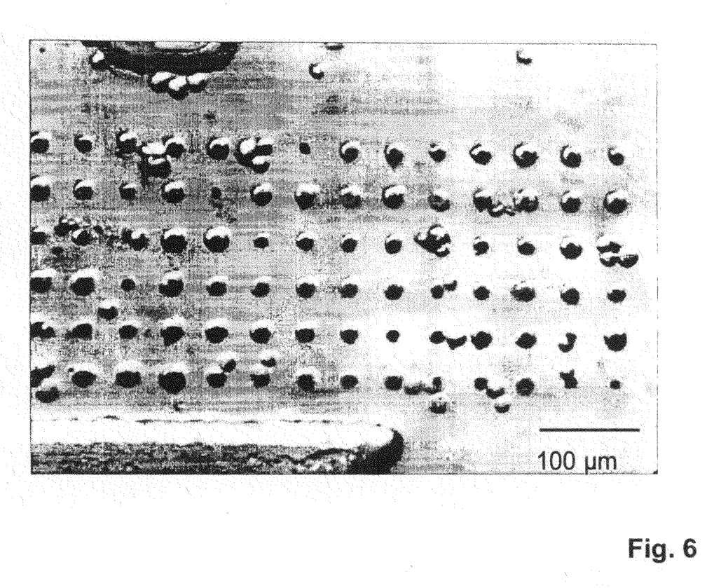

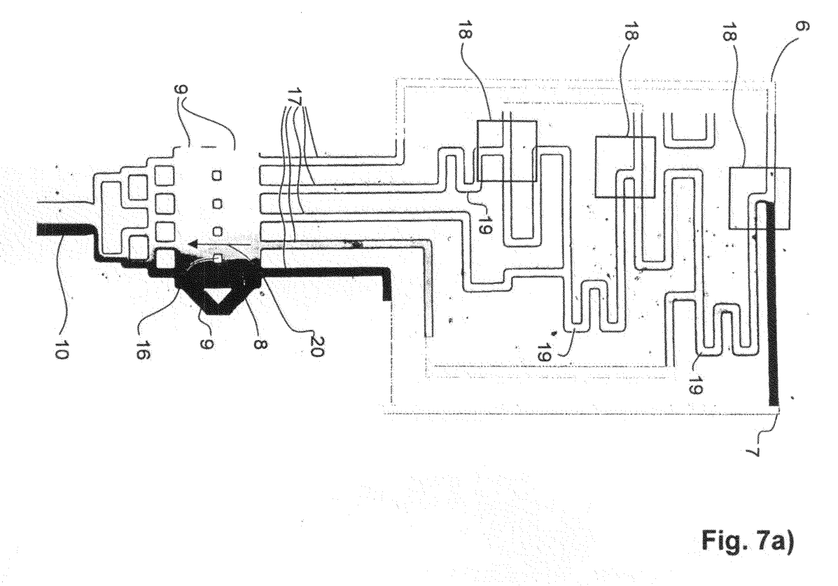

The cell suspension was filled into a pipette tip, which was connected to one of the inlets of the cell loading ports. As the liquid level in this loading port was higher than in the other, empty one, a hydrostatic flow of cells into the incubation chamber was generated. The hydrostatic pressure difference between the inside and the outside of the incubation chamber also induced a minute flow through the orifices, so that single cells were trapped and were immobilized on the orifices. The cells were immobilized in five separate colonies of 200 cells each, so that the system provided a defined number of cells and a homogeneous cell density (FIG. 6).

Due to the larger specific density of the fibroblasts, the cells tend to sediment in the loading pipette. As a result, the cell concentration decreased permanently during the loading process until finally clear medium flowed through the chamber. As soon as all the orifices were occupied by cells, the remaining excess cells were, therefore, washed away. In fact, the cells were only retained in the chamber due to the pneumatic anchoring through the orifices. A control experiment using chamber without orifices yielded the result that no cells remained in the chamber.

During cultivation, the loaded device was placed in a Petri dish, which was filled with 2 ml of medium to prevent the drying out of the cells in the incubation chamber.

The medium was exchanged once a day by hydrostatic flow using a medium filled pipette tip connected to the cell loading port.

### Results & Discussion

### Validation of the Drug Diluter Architecture:

The performance of the drug diluter was first validated qualitatively using blue food color. For this experiment, the micro-fluidic device was bonded onto a glass microscope slide to be able to monitor the different color intensities under an inverted microscope.

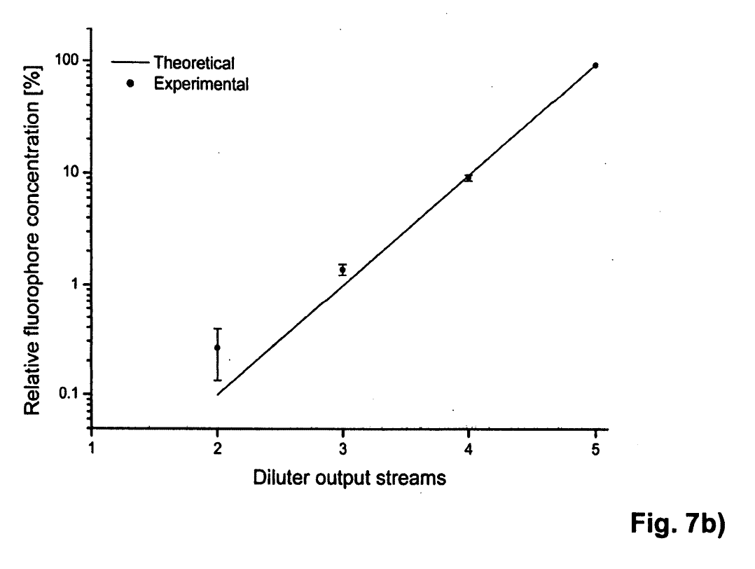

As calculated by our model, the flow rates were set to a ratio of 1:4 for the drug inlet and the buffer inlet at a total flow rate of 1.875 μl/min. FIG. 7 (a) shows a micrograph of the diluter with the three mixing stages 18. The mixing of the color and the buffer solution with a dilution ratio of 9:1 at each node could be qualitatively observed. After mixing, the drug and the buffer flowed through the long meander-shape channels 19, which facilitated complete inter-diffusion.

When entering the incubation chamber 8, all drug streams were fully mixed, and five laminar streams of equal width through the chamber could be observed. At the entrance of the chamber, the streams were completely separated from each other; further down a small degree of diffusion between the streams in the chamber could be observed as expected. However, the streams remained clearly separated and no major inter-diffusion between the neighbouring zones could be observed. Moreover, the cell beds were spaced at a large enough distance and there was no concentration gradient over one of the cell beds (FIG. 3).

For a quantitative evaluation, an aqueous 100-μM fluorescein solution (di-sodium fluorescein, Sigma Aldrich) was filled into the drug inlet, and distilled water was filled into the buffer inlet. The fluorescence intensity was measured using a modified inverted epi-fluorescence microscope with a photo-multiplier module (PMT H5784, Hamamatsu Photonics, Japan) attached to the camera port The light emission from the chip was first spatially discriminated using a 1-mm pinhole and filtered using a 525-nm metallic interference filter (Edmund Optics, USA). FIG. 7 (b) shows a plot of the calculated and the experimentally determined relative fluorophore concentrations. The graph shows that the fluorescence intensities produced at the outputs of the dilution cascade correspond very well to the desired concentrations. As the dilution of the different concentrations was achieved by a cascading structure, the deviation between the desired and achieved concentrations become larger from stage to stage yielding a maximum relative mismatch of 30% for the 0.1% dilution stage. However, this variation can be attributed to geometrical imprecisions in the micro-fluidic network as a consequence of the low resolution of the photolithographic mask. With a standard chromium mask, significantly better result is expected.

### Cell Adhesion:

NHDFs were chosen for the cell-adhesion and drug-screening experiments for several reasons: Like most cells, fibroblasts only adhere to a surface if all culturing -conditions are met. But fibroblasts have the additional advantage that they change their shape to a triangular form upon adhesion, and after adhesion, fibroblasts start to divide when they are in a healthy state and are well supplied with all necessary nutrients. These characteristics allow for a convenient visual observation of the cell status.

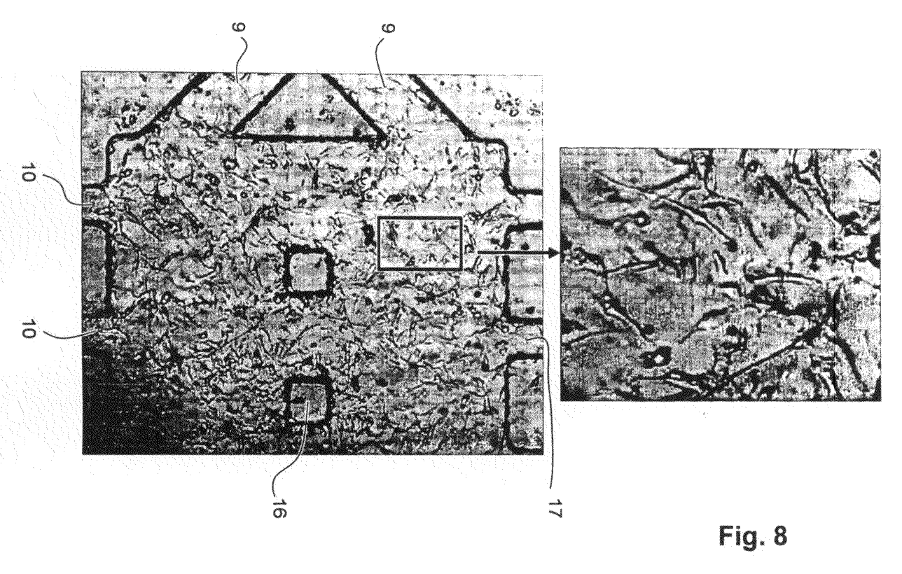

FIG. 8 shows a micrograph of immobilized fibroblasts after 6 days in culture inside the 0.5-μl incubation chamber. Although the fibroblasts were immobilized on the orifices during the loading step and adhered to the laminin-coated surface, the cells expectedly began to migrate away from the orifices already after one day in culture and formed a homogenous cell layer. After 6 days in culture, a confluent layer of cells inside the incubation chamber was observed. This behaviour is desired because cell immobilization is only required during the loading phase to obtain a defined reproducible and homogenous cell population in the incubation chamber.

Once the initial population has been successfully established the cells should freely proliferate to form a confluent layer.

Drug Screening Experiments with Cell Trackers:

To mimic a typical drug-screening procedure, the absorption of a fluorescent cell tracker by immobilized NHDFs from differently diluted streams of the fluorophore was studied. Before the incubation, the chamber was coated with laminin-l (20 μl/ml in TBS) for 30 min before cell loading. Cell preparation and loading was performed as described in the experimental section. In this experiment, the dilute ion and cell exposure process was started already 30 min after immobilization. Green cell tracker (CellTracker Green CMDA C2925, Molecular Probes) with a stock concentration of 100 μM was diluted to 10 μM, 1 μM, 0.1 μM and 0 μM with medium in the diluter stage. The cells were exposed to the five laminar streams of different concentrations at a total flow rate of 1.25 μl/min for 20 min.

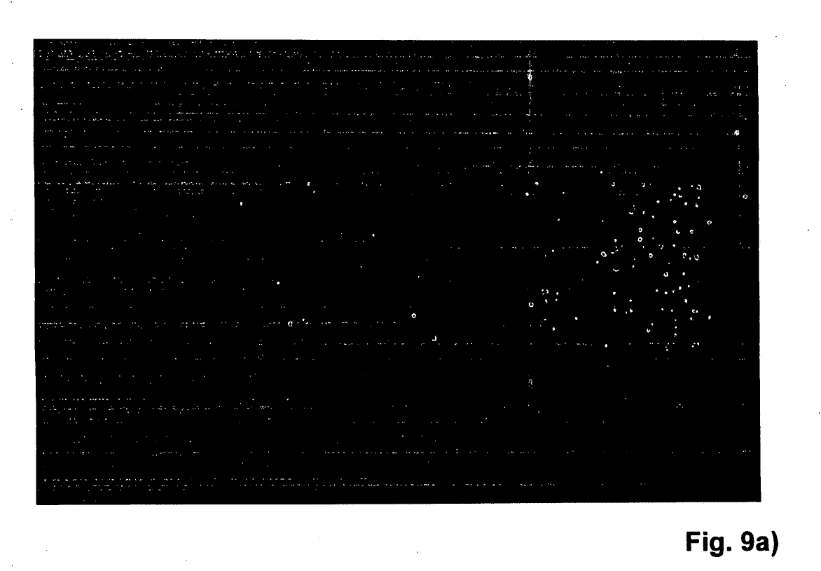

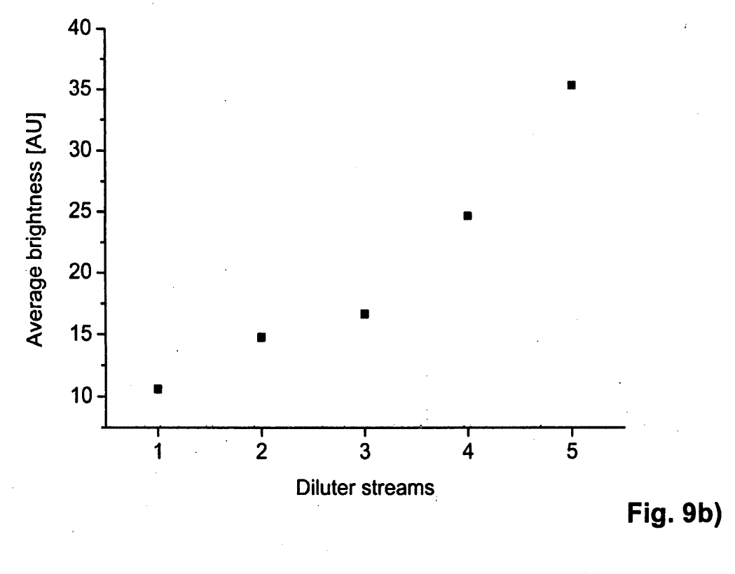

Then, the syringe pump filled with the cell tracker solution was stopped, while the second pump with the medium continued operation to flush the chamber. The presence of the cell tracker was optically monitored as shown in the fluorescence image in FIG. 9 (a). The concentrations increased from the left to the right. A correlation between the cell tracker concentration and the fluorescence intensity in the cell beds was observed.

A more quantitative analysis is shown in FIG. 9 (b) and was performed by image analysis of the acquired digital fluorescence images using the Lspix-5.1 (National Instruments of Standards, USA) software package. The average brightness of a rectangular area over each of the five cell beds comprising 64000 pixels was determined and plotted for each drug stream. While the higher-concentration streams produced significantly different fluorescence intensity in the cell beds, the 0-μM and 0.1-μM streams produced more fluorescence than expected. We attribute this to accidental contamination of the low-concentration streams with the cell tracker during starting the drug pump, which might have led to an intermittently increased drug concentration in streams 1 and 2 before a steady state was established.

FIG. 9 (b) also illustrates that the absorption of the dye in the cell caused a non-linear relationship between the cell tracker concentration in the stream and the corresponding cell fluorescence intensity (note that the drug concentrations are logarithmic). No major cross contamination between the neighbouring streams and cell beds was observable, so that the system met all requirements for a fully integrated cell-screening system.

### CONCLUSION

A combination of a micro-machined cell patterning and immobilization chip with online sample dilution over three orders of magnitude for cell-screening experiments was presented. By combining a small silicon chip for cell immobilization with an elastomeric micro-fluidics structure, a hybrid device featuring the advantages of precision silicon micro-machining and low-cost polymer replication techniques was fabricated. This device allows for arranging defined number of cells in a regular array, which improves the reliability of the experiment and allows for applying statistical methods. The integration of a micro-fluidic dilution cascade reduces both, the reagent consumption and the preparation time.

A successful cell immobilization was achieved within 30 sec and cells were incubated in these devices for 6 days without observing reduced cell proliferation. The diluter stage was validated using a fluorescent dye, and a prototype screening experiment was performed using NHDFs and a fluorescent cell tracker. This shows that all the necessary procedures required for such an assay can be integrated in one system.

### CITED REFERENCES

[1] T. Tokuyama, S. Fujii, K. Sato, M. Abo, and A. Okubo, “Microbioassay system for antiallergic drug screening using suspension cells retaining in a poly(dimethylsiloxane) micro-fluidic device”, Anal. Chem., vol. 77, pp. 3309-3314, 2005.

[2] D. S. Gray, J. L. Tan, J. Voldman, and C. S. Chen, “Dielectrophoretic registration of living cells to a microelectrode array”, Biosens. Bioelectron., vol. 19, pp. 771-780, 2004.

[3] N. Manaresi, A. Romani, G. Medoro, L. Altomare, A. Leonardi, M. Tartagni, and R. Guerrieri, “A CMOS chip for individual cell manipulation and detection”, IEEE J.

Solid-State Circuits, vol. 38, pp. 2297-2305, 2003.

[4] K. S. Yun and E. Yoon, “Micro/nanofluidic device for single-cell-based assay”, Biomedical Microdevices, vol. 7, pp. 3540, 2005.

[5] H. Thielecke, T. Stieglitz, H. Beutel, T. Matthies, H. Heinrich, and J. U. Meyer, “Fast and precise positioning of single cells on planar electrode substrates—A new method with potential benefits for biosensor applications and the study of neural networks”, IEEE Eng. Med. Biol. Mag., vol. 18, pp. 48-52, 1999.

[6] F. Greve, J. Lichtenberg, K. -U. Kirstein, U. Frey, J. -C. Perriard, and A. Hierlemann, “Perforated CMOS microchip for immobilization and activity monitoring of electrogenic cells”, Journal of Microelectromechanical Systems, submitted.

[7] C. W. Li, C. N. Cheung, J. Yang, C. H. Tzang, and M. S. Yang, “PDMSbased micro-fluidic device with multi-height structures fabricated by singlestep photolithography using printed circuit board as masters”, Analyst, vol. 128, pp. 1137-1142, 2003.

[8] H. Sorribas, C. Padeste, and L. Tiefenauer, “Photolithographic generation of protein micropatterns for neuron culture applications”, Biomaterials, vol. 23, pp. 893-900, 2002.

[9] G. M. Whitesides, E. Ostuni, T. Shuichi, X. Jiang, and D. E. Ingber, “Soft Lithography in Biology and Biochemistry”, Annu. Rev. Biomed. Eng. 2001, vol. 3, pp. 335-373, 2001.

[10] J. K. Chang, H. Bang, S. J. Park, S. Chung, C. Chung, and D. C. Han, “Fabrication of the PDMS microchip for serially diluting sample with buffer”, Microsystem Technologies, vol. 9, pp. 555-558, 2003.

[11] S. C. Jacobson, T. E. McKnight, and J. M. Ramsey, “Micro-fluidic devices for electrokinetically driven parallel and serial mixing”, Anal. Chem., vol. 71, pp. 4455-4459, 1999.

[12] C. Neils, Z. Tyree, B. Finlayson, and A. Foich, “Combinatorial mixing of micro-fluidic streams”, Lab On A Chip, vol. 4, pp. 342-350, 2004.

[13] S. K. W. Dertinger, D. T. Chiu, N. L. Jeon, and G. M. Whitesides, “Generation of gradients having complex shapes using micro-fluidic networks”, Anal. Chem., vol. 73, pp. 1240-1246, 2001.

[14] T. Baier, K. S. Drese, F. Schönfeld, and U. Schwab, “A μ-fluidic mixing network”, Chemical Engineering & Technology, vol. 28, pp. 362-366, 2005.

[15] A. D. Stroock, S. K. W. Dertinger, A. Ajdari, I. Mezic, H. A. Stone, and G. M. Whitesides, “Chaotic mixer for microchannels”, Science, vol. 295, pp. 647-651, 2002.

### LIST OF REFERENCE NUMERALS

1 silicon chip with perforated membrane

2 elastomeric support plate

3 elastomeric micro-fluidic cover

4 cell

5 holes, orifices

6 inlet for buffer

7 inlet for drug

8 incubation chamber

9 cell loading ports

10 waste outlet

11 silicon

12 silicon dioxide (0.1 micrometer)

13 silicon nitride passivation

14 KOH etching

15 HF etching

16 support

17 inlets for test solutions into 8

18 dilutions stage

19 meander

20 flow direction of the test solutions

1. A chemical assay on sensing objects comprising
a base element with on a surface an array of multiple immobilisation points for individual sensing objects or groups of a sensing objects, and
a flow chamber bordered on a first lateral side by said base element and covering said base element at least in the region with the array of immobilisation points,
wherein the flow chamber on an entry-side comprises at least one inlet for the introduction of different test solutions into the flow chamber in a flow direction, and on an exit-side located opposite to the entry-side comprises at least one outlet for the test solutions, wherein these inlets are located substantially in a plane parallel to the surface of the base element and spaced apart in a direction perpendicular to the flow direction of the test solutions such that the test solutions flow across over the array of multiple immobilisation points and cells located thereon in a parallel laminar flow, such that there is no interference and/or or well-defined and reproducible interference between the flow of the different test solutions over defined groups of the array of multiple immobilisation points.

2. The chemical assay of claim 1, wherein the flow chamber comprises at least two inlets.

3. The chemical assay of claim 1, wherein the sensing objects are selected from the group consisting of cells and organic or inorganic particles.

4. The chemical assay of claim 1, wherein the flow chamber comprises at least two sensing object loading ports.

5. The chemical assay of claim 1, wherein the assay comprises a micro-fluidic dilution element for automatically generating different concentrations of test solutions from at least one basic liquid introduced via a first inlet into the dilution element and at least one test liquid or drug introduced via a second inlet into the dilution element, and wherein the generated different test solutions or drug solutions are introduced into the flow chamber via the different inlets.

6. The chemical assay of claim 1, wherein the immobilisation points are pneumatic anchoring points for individual sensing objects.

7. The chemical assay of claim 20, wherein the diameter of the holes is smaller than the average diameter of the cells.

8. The chemical assay of claim 1, wherein the array comprises between about 10 to about 5000 immobilisation points, wherein the immobilisation points are grouped into a number of individually defined groups corresponding to a number of inlets for the introduction of different test solutions.

9. The chemical assay of claim 1, wherein the flow chamber has a volume in the range of about 0.1 to about 100 μL.

10. The chemical assay of claim 1, wherein the flow chamber comprises at least two outlets for the test solutions, or an equal number of outlets as there is inlets, wherein thee outlets are located opposite and in a spacing adapted to the one or identical to the one of the inlets.

11. The chemical assay of claim 1, wherein the base element is selected from the group consisting of a plastics element, a ceramics element, a glass element, a silicon element, a silicon orifice chip, and a silicon orifice chip based on silicon-on-insulator-technology, wherein the base element has a size in the range of about 1×1 mm² to about 20×20 mm².

12. The chemical assay of claim 1, wherein the base element is at least partially embedded in a support plate, the support plate having a cover plate on its surface wherein the cover plate covers the base element, said cover plate or support plate comprising a microfluidic dilution system given by a system of cascading channels with dilution stages, wherein the support plate and/or the cover plate are based on an plastics, ceramics, glass or silicon or a combination thereof.

13. The chemical assay of claim 1, wherein there is provided at least three inlets substantially equally spaced apart by between about 200 to about 1500 μm in a direction perpendicular to the flow direction, wherein the inlets have a diameter in the range of 50 to about 200 μm, and wherein the flow rate in the flow chamber is in the range of about 4 to about 50 μL min⁻¹, and wherein the micro-fluidic dilution system provides solutions in a concentration range of about 3 to about 6 orders of magnitude.

14. The chemical assay of claim 1, further comprising an analysis unit or an optical analysis unit.

15. The chemical assay of claim 1, wherein the flow chamber is selected from the group consisting of a substantially contiguous cavity and a substantially contiguous cavity locally supported by supports.

16. A method for chemical automated investigation of sensing objects using an assay as defined in the preceding claims, comprising the steps of
(I) introducing sensing objects into a flow chamber, wherein the sensing objects are immobilized on immobilization points;
(II) testing compound dilution, by introducing test solutions into the flow chamber via inlets and exposing the immobilised sensing objects to the test solutions by parallel laminar flow over the sensing objects; and
(III) analyzing the influence on the sensing objects, by means of optical interrogation.

17. The method of claim 16, wherein the sensing objects are introduced into the flow chamber and immobilised on the immobilisation points by means of hydrostatic pressure, wherein the immobilisation points are holes with a diameter smaller than the average diameter of the sensing objects, penetrating the base element.

18. A method of making an assay according to claim 1, wherein the base element is produced from a silicon chip by means selected from reactive-ion-etching and anisotropic wet etching, the base element being embedded in an elastomeric support plate, wherein a cover plate with a flow chamber and the inlets and outlets as well as an integrated microfluidic dilution system is produced from an elastomeric material based on a template comprising the dilution topology, and wherein the cover plate is attached and connected to the support plate with the embedded base element.

19. The chemical assay of claim 1, wherein the flow chamber comprises at least two sensing object loading ports, wherein the sensing object loading ports are located on opposite lateral sides or on edges of the flow chamber.

20. The chemical assay of claim 1, wherein the immobilisation points are pneumatic anchoring points for individual cells, and wherein the immobilisation points are given as holes penetrating the base element.

21. The chemical assay of claim 7, wherein the diameter of the holes ranges from about 1 to about 20 μm.

22. The chemical assay of claim 8, wherein the individual groups are spatially separated from each other in a direction orthogonal to the direction of the flow.

23. The chemical assay of claim 3, wherein the organic or inorganic particles are beads.
